(19) United States
(12) Patent Application Publication
(10) Pub. No.: US 2002/0133520 A1
(43) Pub. Date: Sep. 19, 2002

(54) Method of preparing a multimedia recording of a live presentation

(76) Inventor: Matthew Tanner, Pittsburgh, PA (US)

Correspondence Address: David C. Jenkins, Eckert Seamans Cherin & Mellott, LLC, 600 Grant Street, 44th Floor, Pittsburgh, PA, 15219, US

(21) Appl. No.: 09/809,659

(22) Filed: Mar. 15, 2001

(51) Int. Cl. G06F 17/24

(52) U.S. Cl. 707/517

(57) ABSTRACT

A method of preparing a multimedia recording of a live presentation, where the presentation comprising a plurality of events, is provided. The method includes the steps of, (a) preparing a recording means and gathering information associated with said presentation, (b) recording the events of said presentation, (c) digitizing any event recording not digitally recorded, (d) transferring said recordings to said electronic storage medium, (e) processing said recordings to create a digital multimedia presentation wherein said events are presented in a visual and audio format and the staging of said visual and audio formats are automatically synchronized, and displaying said digital multimedia presentation.

### BACKGROUND OF THE INVENTION

1. Field of the Invention

The present invention relates to a method of preparing a recording of a live presentation and, more specifically, to a method of preparing a multimedia recording of a live presentation that includes both an audio component and a visual component, such as slides, wherein the audio component and the visual component are synchronized.

2. Description of the Prior Art

Businesses regularly have live presentations. Presentations are used to convey information to employees, customers, and other businesses. Presentations typically include one or more speakers who uses visual aids, such as a video presentation or slides, to present information on a topic. Today, most “slides” are actually computer generated graphics projected onto a screen. Traditionalists, however, may still use transparent slides with a projector or overhead projector. Hard copies of the slides are often distributed to the attendees along with other written materials.

Recording services for presentations have been developed so that people who were unable to attend the presentation may receive the benefit of the presentation. One of the simplest ways to record the event is to video tape record the presentation. Thus, a user may watch the video tape and may be provided with hard copies of the visual aids. The disadvantage of this method is that there is no method of synchronizing the display of the hard copy of the slides to what is being presented on the video tape. Additionally, there is no means to quickly skip irrelevant material or to search the tape for relevant material. Also, the user must have a copy of the tape in their possession in order to use the tape.

Some of these disadvantages have been addressed by digitally recording the presentation for use in a multimedia rebroadcast of the presentation. The digital recording may be stored at a remote location and accessed by multiple users at one time. Additionally, provided the digital recording is structured in a typical fashion, that is, in “chapters,” the user may quickly skip irrelevant materials. These digital recordings may also be copied to a digital storage medium such as a CD-ROM. The digital recording may further include digital versions of the slides. The slides may be displayed at an appropriate time during the presentation. The disadvantage to these systems is that each presentation must be individually coded. That is, the timing of the display of the slides relative to the video or audio recording must be individually programmed into the final multimedia rebroadcast. Such a method of individually coding the multimedia rebroadcast may require an extended period of time. As information quickly becomes outdated, this severely limits the value of the multimedia rebroadcast. Additionally, this method does not provide a means to search for selected topics in the presentation.

Therefore, there is a need for a method of preparing a multimedia recording of a live presentation that allows for the automatic synchronization between an audio or video recording and the display of the slides used during the presentation.

There is a further need for a method of preparing a multimedia recording of a live presentation that allows the user to search the presentation for selected topics.

### SUMMARY OF THE INVENTION

These needs, and others, are satisfied by the present invention which provides a method of preparing a multimedia recording of a live presentation that includes a step of automatically synchronizing the audio and/or video recording with the timing of the presentation of the visuals. This is conveniently assisted by a presentation logging program that is installed on the presenter's computer prior to the presentation. The presentation logging program works with the presentation software used to display the electronic slides used during the presentation. These “slides” are actually individually named in the display program. The presentation logging program includes a time index. Each time a slide is used, the presentation logging program records information such as the name of the file and the time, relative to the time index, at which the slide was shown, how long the slide was shown, and when the slide was no longer displayed. The audio and/or video recording includes a similar time index. Both the audio and/or video recording time index and the logging program time index begin at the same time. By processing the audio and/or video recording and the logging program information, a multimedia stream is automatically generated that displays the visuals at the appropriate time during the audio and/or video recording. That is, the visuals and the audio and/or video recording are synchronized.

The method further includes a step of generating an electronic transcript of the event. The electronic transcript also includes a time index. Portions of the electronic transcript are associated with the relevant time in the time index. A word index for the electronic transcript is also created. Thus, using the time index as a foundation, the electronic transcript can be processed with the audio and/or video recording and the logging program information to create a media stream that produces a synchronized slide show, audio and/or video recording, and a visible transcript. Additionally, the transcript may be searched for relevant words or phrases so that the user may jump to the relevant point in the presentation.

The slides, the logging program data and time index, and audio and/or video recording can be recorded digitally. If this information is not created digitally, it can be converted into a digital format. This information can then be transmitted over an electronic network, such as the Internet, to a processing computer. The processing computer is used to automatically create the final media stream. The final media stream can then be displayed over the electronic network or copied onto a digital storage medium, such as a CD-ROM. By having the method utilize digital technology, the final media stream can be produced rapidly.

### DESCRIPTION OF THE DRAWINGS

These and other advantages of the present invention will become readily apparent upon consideration of the following detailed description and attached drawing, wherein:

FIG. 1 is a representation of the steps for preparing a multimedia recording of a live presentation.

FIG. 2 is a schematic representation of the recording of an event and the viewing of a multimedia recording by a user.

FIG. 3 is a view of the media stream as shown on a computer.

### DETAILED DESCRIPTION OF A PREFERRED EMBODIMENT

As used herein, “digital storage medium” includes, but is not limited to, CD-ROMs, DVDs, tape media, magnetic media, and flash memory.

As used herein, “transferred” when used in association with a digital recording or a computer file includes both “copying” and “moving” as those words are used in the industry.

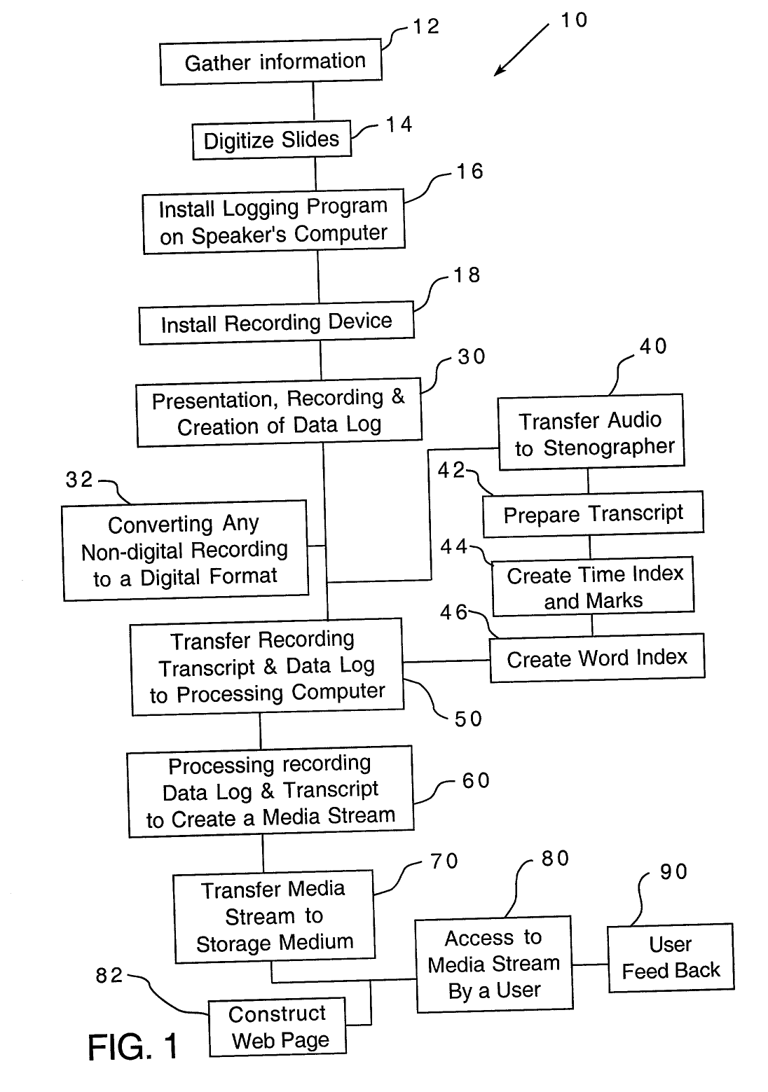

As shown in FIG. 1, a method of preparing a multimedia recording begins with the preparation 10. The preparation 10 for recording a presentation 30 includes gathering 12 information about the presentation 30. Information gathered 12 may include, for example, the name of the organization sponsoring the presentation, the names of those who will be making the presentation, the date and time of the presentation, and a list of attendees. This basic information is then stored electronically as an electronic record. The electronic record can be used to begin designing a document that can be viewed with a web browser. Additionally, the visual aids to be used by each speaker 100 can be incorporated into the electronic record. Typically, these visual aids will be computer files used to create projected images or “slides.” If the speaker 100 is more traditional and has only film slides or overhead projector transparencies, the film slides or overhead projector transparencies can be prepared for incorporation to the digital record by digitizing 14 the film slides or overhead projector transparencies.

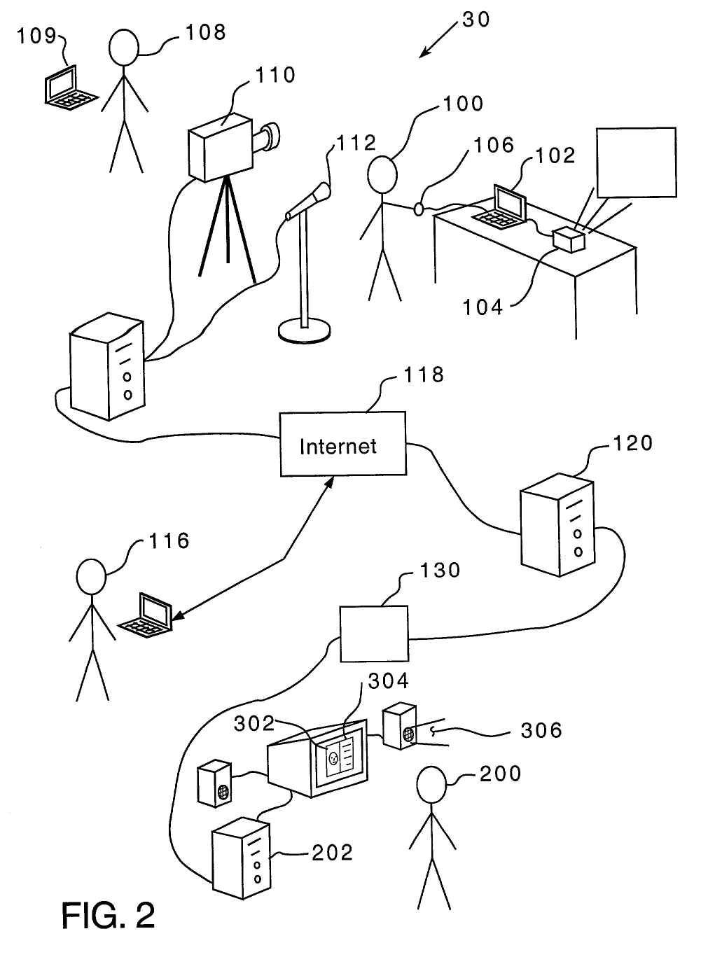

As shown on FIG. 2, a speaker 100 typically uses an electronic slide system that includes a series of electronic slides stored on a computer 102 and a projector 104. A display program on the speaker's computer 102 is structured to display the electronic slides through the projector 104. The speaker 102 will switch between slides by using the computer mouse 106 or similar input device. For example, the speaker 100 starts the display program and displays the first slide. Pressing one button on the mouse 106 will cause the display program to show the next electronic slide in the series. If the mouse 106 is a two button mouse, pressing on the second button will cause the display program to show the prior slide in the series. A further step in the preparation is to install 16 a logging program on the computer 102 of each speaker 100. The logging program includes a time index and monitors the display program. The logging program creates a data log that is a record of the time that each electronic slide is displayed, e.g. the data log is a record of each slide in the presentation and at what time the speaker 100 presses a mouse button. The logging program also records when other programs, such as a media player, is started and what media file is played. The logging program is started by a batch program, which is also copied to the speaker's computer 102. That is, the logging program, and therefore the time index, starts when the batch program is run. Alternatively, the data log can be created manually. To accomplish this a worker 108 with a computer 110 attends the presentation. The computer 110 used by the worker 108 includes a manual logging program with a time index. Each time the speaker 100 uses a slide, the worker 108 inputs data into the manual logging program. The input from the worker 108 indicates when and which slide was displayed.

A further step in the preparation is to install 18 an audio and/or video recording device at the presentation site. Preferably, a digital recording device is used, such as a digital video recorder 110 or a digital audio recorder 112. The recording device 110, 112 is structured to record an audio recording and/or a video recording. The audio recording and/or a video recording includes a time index in the audio recording and/or the video recording. The recording device 110, 112 is started by the batch program installed on the speaker's computer. That is, the recording device 110, 112, and the time index, starts when the batch program is run.

The batch program is also structured to start the display software. Thus, a single icon on the computer 102 used by the speaker 100, e.g. an icon labeled “press here to begin,” runs the batch program which starts the display program, the logging program, and recording device. When the logging program and recording device are started by the batch program, the logging program time index and recording device time index are synchronized.

After the preparations are made, the presentation is made and recorded 30. The presentation typically includes many events. An event includes, but is not limited to, such things as the speaker 100 speaking, and visual events such as the speaker 100 displaying one or more slides, or the speaker 100 showing a video presentation. Each event is recorded, preferably in a digital format. The recording begins when the speaker runs the batch program previously installed on their computer 102. This batch program starts both the recording device and the logging program. Thus, the recording and the data log created by the logging program have a synchronized time index. Alternatively, as noted above, the data log may be created manually. After the presentation is over, there is a time indexed recording of the presentation and a time indexed data log as to when the visual events occurred. If any recording of an event is not recorded in a digital format, the recording is converted 32 to a digital format.

The audio recording is preferably transferred 40 to a stenographer 116 who prepares 42 a transcript. The transcript is stored in an electronic format. The electronic transcript is coded 44 with a time index. The electronic transcript is further coded with “markers,” which are computer codes that are not displayed as part of the transcript. The markers relate a portion of the electronic transcript to a point in the time index. For example, the portion of the transcript for the speaker's introduction is related to the beginning of the time index. A digital word index of the electronic transcript is also created 46.

The time indexed audio and/or video recording, the time indexed data log, and/or the time indexed transcript are transferred 50 to a processing computer 120. The digital recordings, the data log and electronic transcript may be transferred over an electronic network 118, such as a company intranet or the Internet. Alternatively, the digital recordings, data log and electronic transcript may be transferred to a digital storage medium and transported to the processing computer 120. The processing computer 120 is structured to create a media stream that includes both audio and visual components. The visual components include the slides, any video presentation, the recorded video and the electronic transcript. The processing computer 120 automatically assembles 60 the media stream by incorporating the components into an integrated file. The timing of when the slides or video presentation are displayed in the media stream relative to audio and/or video recording and the timing of what portion of the electronic transcript is displayed in the media stream relative to audio and/or video recording is controlled by the time index. Thus, the media stream 130 includes synchronized audio and visual components. The media stream 130 may also include additional advertising materials.

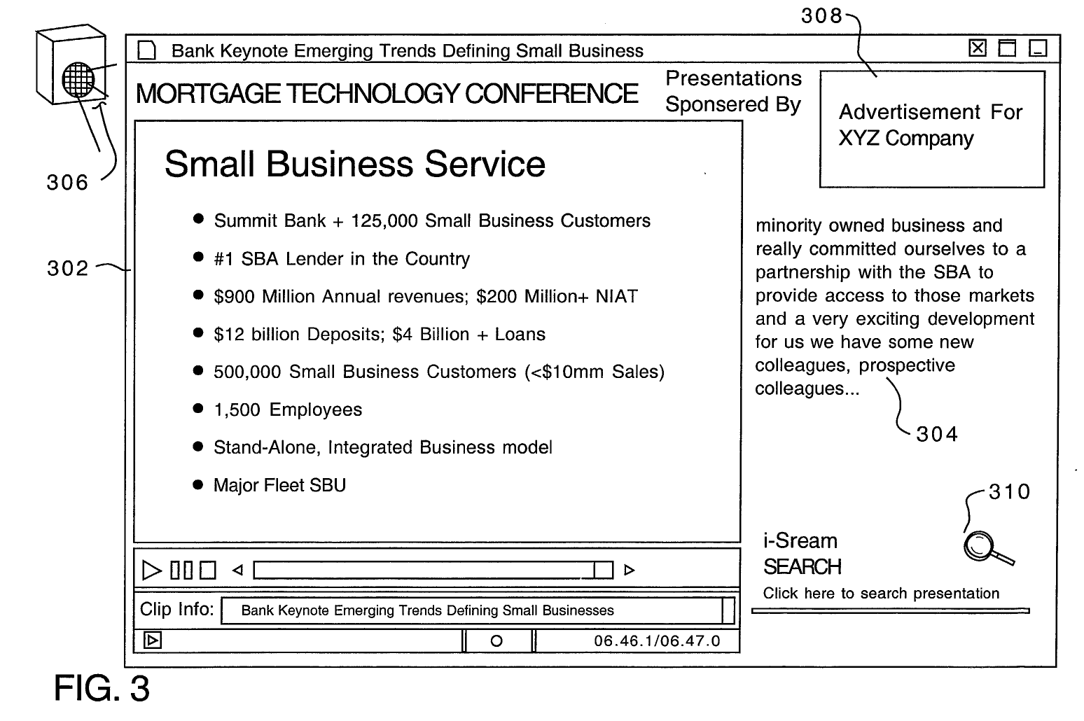

Once the processing computer 120 creates the media stream 130, the media stream 130 is stored on a digital storage medium. If the digital storage medium is a CD-ROM, the CD-ROM may be shipped to a user 200. Alternatively, a user 200 may access 80 the digital storage medium through an electronic network 118. The media stream 130 may be viewed and heard on a device such as a computer 202. As shown on FIG. 3, the user's computer 202 includes a multimedia program that is structured to display the slides 302 and the electronic transcript 304. The multimedia program also plays the audio recording and/or video recording 306. The multimedia program may also display the additional advertising materials 308. The multimedia program is also structured to allow the user 200 to search 310 the word index of the electronic transcript. When a user 200 locates a certain word or phrase, the multimedia program will display that portion of the media stream 130.

If the media stream 130 is accessed via an electronic network 118, it is convenient to construct 82 a web page relating to the presentation. The web page may include information gathered as part of the preparation 10. The web page will also gather 90 user feed back, such as their name, e-mail address, occupation, and so forth. The user information is stored in the electronic record. A user may need to pay for access to the media stream, so the web page may be structured to collect information such as a credit card number. The web page may also be structured to allow the user to submit comments regarding the presentation. User comments, as well as other information in the electronic record, may be used for marketing purposes. For example, users who attended and/or viewed a presentation regarding banking may be alerted to a future presentation regarding banking or similar services.

While specific embodiments of the invention have been described in detail, it will be appreciated by those skilled in the art that various modifications and alternatives to those details could be developed in light of the overall teachings of the disclosure. For example, there is no requirement that electronic transcript be prepared. The media stream could be produced having only the audio and/or video recording synchronized with the visual events. Accordingly, the particular arrangements disclosed are meant to be illustrative only and not limiting as to the scope of invention which is to be given the full breadth of the claims appended and any and all equivalents thereof.

What is claimed is:

1. A method of preparing a multimedia recording of a live presentation, said presentation comprising a plurality of events, said method comprising the steps of:
(a) preparing a recording means and gathering information associated with said presentation;
(b) recording the events of said presentation;
(c) digitizing any event recording not digitally recorded;
(d) transferring said recordings to a processing computer;
(e) processing said recordings to create a digital multimedia presentation wherein said events are presented in a visual and audio format and the staging of said visual and audio formats are automatically synchronized; and
(f) displaying said digital multimedia presentation.

2. The method of claim 1, wherein said events include a verbal presentation and a visual presentation.

3. The method of claim 2, wherein said visual presentation includes a plurality of slides.

4. The method of claim 3, wherein said step of recording the events of a live presentation includes the steps of:
(a) digitally recording said audio presentation; and
(b) digitally recording said slides.

5. The method of claim 4, wherein said step of digitally recording said live presentation includes the steps of:
(a) creating a time index within said audio recording; and
(b) using a logging program that creates a time index and a data log which records information indicating when, relative to the logging program time index, each said slide is used and for how long each said slide is visible to an audience.

6. The method of claim 5, wherein said step of processing said recordings to create a digital multimedia presentation wherein said events are presented in a visual and audio format and the staging of said visual and audio formats are synchronized includes the step of creating a media stream having an audio component and an visual component, wherein said audio component corresponds to said audio recording and said visual component comprises a series of said slides which are presented in a sequence according said data log.

7. The method of claim 6, wherein said step of displaying said digital multimedia presentation includes the step of transferring said media stream to an electronic storage medium.

8. The method of claim 7, wherein said electronic storage medium is a CD-ROM.

9. The method of claim 6, wherein said step of displaying said digital multimedia presentation includes the step of providing access to said media stream through an electronic network.

10. The method of claim 6, wherein said step of transferring said recordings to said electronic storage medium includes the step of transferring said digital audio recording and said digital slides through an electronic network.

11. The method of claim 16, wherein said presentation includes a speaker using a computer to present a series of slides and wherein said step of preparing a recording means and an gathering information associated with said presentation includes the steps of:
(a) installing said logging program on the computer used by said speaker;
(b) gathering and recording data relevant to the presentation; and
(c) preparing an Internet web page which displays said data relevant to the presentation.

12. The method of claim 11, wherein said step of displaying said digital multimedia presentation includes the step of providing a hypertext link on said web page which accesses said media stream.

13. The method of claim 1, wherein said step of recording the events of a live presentation includes the steps of:
(a) preparing an electronic transcript corresponding to said audio recording;
(b) creating a time index in said electronic transcript which corresponds to said audio recording time index; and
(c) associating portions of the electronic transcript with said electronic transcript time index.

14. The method of claim 13, wherein said step of processing said recordings to create a digital multimedia presentation wherein said events are presented in a visual and audio format and the staging of said visual and audio formats are synchronized includes the steps of:
(a) using a logging program that creates a time index and a data log which records information indicating when, relative to the logging program time index, said speaker uses a slide and how long each said slide is visible to an audience
(b) creating a media stream having an audio component and an visual component, wherein said audio component corresponds to an audio recording and said visual component comprises a series of said slides used by said speaker which are presented in a sequence according to the data log and the relevant portion of said electronic transcript according said electronic transcript time index.

15. The method of claim 14, wherein said step of processing said recordings to create a digital multimedia presentation wherein said events are presented in a visual and audio format and the staging of said visual and audio formats are synchronized includes the step of creating a word index of said electronic transcript.

16. The method of claim 15, wherein said step of displaying said digital multimedia presentation includes the steps of:
(a) allowing a user to search said word index for a specific word or phrase; and
(b) presenting those portions of said media stream relating to said specific word or phrase.

17. The method of claim 16, wherein said step of displaying said digital multimedia presentation includes the step of transferring said recording of said media stream to an electronic storage medium.

18. The method of claim 17, wherein said electronic storage medium is a CD-ROM.

19. The method of claim 18, wherein said step of displaying said digital multimedia presentation includes the step of providing users access to said recording of said media stream through an electronic network selected from the group consisting of a company intranet and the Internet.

20. The method of claim 19, wherein said step of displaying said digital multimedia presentation includes the steps of:
(a) providing an electronic data storage medium;
(b) providing users access to said electronic data storage medium; and
(c) recording users comments in said electronic data storage medium.

21. The method of claim 14, wherein said step of transferring said recordings to said electronic storage medium includes the step of transferring said digital audio recording and said digital slides through an electronic network.

22. The method of claim 14, wherein said presentation includes a speaker using a computer to present a series of slides and wherein said step of preparing a recording means and gathering information associated with said presentation includes the steps of:
(a) installing said logging program on the computer used by said speaker;
(b) gathering and recording data relevant to the presentation; and
(c) preparing an Internet web page which displays said data relevant to the presentation.

23. The method of claim 1,. wherein said step of displaying said digital multimedia presentation includes the step of presenting advertising adjacent to said digital multimedia presentation.

24. The method of claim 1, wherein said presentation includes a speaker using a computer to present a series of slides and wherein said step of preparing a recording means and an gathering information associated with said presentation includes the step of installing a logging program on the computer used by said speaker wherein said logging program is structured to create a time index and a data log which records information indicating when, relative to the logging program time index, each said slide is used and for how long each said slide is visible to an audience.

25. The method of claim 24, wherein said step of preparing a recording means and an gathering information associated with said presentation includes the steps of:
providing a digital recording device structured to record said presentation and include a time index within said recording; and
installing a batch program on the computer used by said speaker wherein said batch program is structured to start said logging program and said digital recording device.

26. The method of claim 25, wherein said step of processing said recordings to create a digital multimedia presentation wherein said events are presented in a visual and audio format and the staging of said visual and audio formats are synchronized includes the step of creating a media stream having an audio component and an visual component, wherein said audio component corresponds to an audio recording of said presentation and said visual component comprises a series of said slides which are presented in a sequence according said data log.
